(19) United States
(12) Patent Application Publication
(10) Pub. No.: US 2025/0305536 A1
(43) Pub. Date: Oct. 2, 2025

(54) ARTICULATED COUPLING ARRANGEMENT FOR A THREE-POINT POWER LIFT OF AN AGRICULTURAL TRACTOR

(71) Applicant: DEERE & COMPANY, MOLINE, IL (US)

(72) Inventors: ABHIJIT HINGNE, KHAMGAON (IN); ACHIM R. SCHIBEL, HEIDELBERG (DE)

(21) Appl. No.: 19/073,201

(22) Filed: Mar. 7, 2025

(30) Foreign Application Priority Data
Mar. 27, 2024 (EP) 24166718.7

(51) Int. Cl. F16C 11/04; A01B 59/06; F16C 19/06

(52) U.S. Cl. CPC F16C 11/04; A01B 59/066; F16C 19/06

(57) ABSTRACT

An articulated coupling arrangement for a three-point power lift of an agricultural tractor includes a lifting arm articulated to be raised and lowered by a lifting mechanism, a lifting spindle connected to a free end of the lifting arm in a bearing position for pivoting actuation of a lower link having a coupling arrangement for reversible attachment of an attachment interface, first and second opposing fork cheeks with receiving bores flush along a joint axis being formed on the lifting spindle, through which receiving bores a retaining bolt is guided, and a bearing ball guided on the retaining bolt being supported on a stop formed on the retaining bolt such that the bearing ball can be braced by a fastening element engaging the retaining bolt with respect to the first fork cheek in a rotationally conjoint manner in a predefined coupling position between the first and second fork cheeks.

### CROSS-REFERENCE TO RELATED APPLICATIONS

This application claims priority to European Patent Application No. 24166718.7, filed Mar. 27, 2024, which is hereby incorporated by reference.

### FIELD OF THE DISCLOSURE

The disclosure relates to an articulated coupling arrangement for a three-point power lift of an agricultural tractor.

### BACKGROUND

Agricultural tractors can include a three-point hitch for attaching implements to the tractor. The three-point hitch includes a pair of lower links and an upper link. The three-point hitch can include a hydraulically actuated lifting apparatus with a pair of lifting arms connected to the pair of lower links. The pair of lower links and the upper link have coupling hooks for receiving complementary fastening elements of an implement.

### SUMMARY

The disclosure relates to an articulated coupling arrangement for a three-point power lift of an agricultural tractor, comprising a lifting arm articulated in a manner fixed on the tractor, which lifting arm can be raised and lowered by means of a lifting mechanism, and a lifting spindle connected to a free end of the lifting arm in a bearing position for pivoting actuation of a lower link which has a coupling arrangement for reversible attachment of an attachment interface, wherein opposing fork cheeks with receiving bores which are flush along the joint axis are formed on the lifting spindle, through which receiving bores a retaining bolt is guided.

Three-point power lifts of conventional design generally comprise a hydraulically actuable lifting mechanism with left and right lifting arms which are articulated in an upper region of a differential housing of an agricultural tractor and can be raised and lowered by means of associated left and right hydraulic cylinders, as well as left and right lower links which are mounted at lower fastening points of the three-point power lift in a vertically pivotable manner and are movement-connected to the lifting arms via length-adjustable lifting spindles. A central upper link is furthermore present which is suspended at an upper fastening point of the three-point power lift in a vertically pivotable manner. Both the lower links and the upper link have detachable coupling hooks for receiving complementary coupling elements of an accessory or supplementary device to be attached thereto. Each of the lifting spindles is connected to a free end of the lifting arm in the region of an associated bearing point, the bearing point normally being formed by a cylindrical bearing journal which is guided through bearing bores which are flush with one another and which are formed in opposite fork cheeks or fork cheeks which run parallel to one another of the lifting spindle and in a fastening eye, around which the fork cheeks engage, of the lifting arm.

The lifting loads or movements which occur during operation of the three-point power lift at the bearing point lead, according to experience, to increased wear of the cylindrical bearing journal within the bearing bores in particular in the region of the single fastening eye.

The object of the present disclosure is therefore to optimize an articulated coupling arrangement of the above-mentioned type in terms of operationally induced wear of the bearing point.

This object is achieved by an articulated coupling arrangement for a three-point power lift of an agricultural tractor having the features of one or more embodiments disclosed herein.

The articulated coupling arrangement for a three-point power lift of an agricultural tractor comprises a lifting arm articulated in a manner fixed on the tractor, which lifting arm can be raised and lowered by means of a lifting mechanism, and a lifting spindle connected to a free end of the lifting arm in a bearing position for pivoting actuation of a lower link which has a coupling arrangement for reversible attachment of an attachment interface, opposing fork cheeks with receiving bores which are flush along the joint axis being formed on the lifting spindle, through which receiving bores a retaining bolt is guided. In this case, a bearing ball guided on the retaining bolt is supported on a stop formed on the retaining bolt in such a manner that the bearing ball can be braced in a rotationally conjoint manner in a predefined coupling position between the fork cheeks by means of a fastening element which engages on the retaining bolt with respect to one of the fork cheeks, the bearing ball being accommodated within a fastening eye of the lifting arm for the formation of the bearing point of a bearing running surface formed in a complementary manner.

Since both the bearing ball and the retaining bolt running therein are braced in a rotationally conjoint manner and thus fixed with respect to the fork cheek, the retaining bolt is not exposed to the movements which occur at the bearing point and thus operationally induced wear caused in this regard. The retaining bolt merely serves here to support the lifting loads which occur at the bearing point or the rotationally conjoint bracing of the bearing balls with respect to the fork cheek by means of the fastening element. The larger bearing running surface of the bearing balls in comparison with the otherwise normal use of a cylindrical bearing journal also leads to correspondingly reduced wear of the bearing point.

The bearing ball involves a separate component which is pushed onto the cylindrical retaining bolt with as little play as possible or in a form-fitting manner and can be removed or replaced where necessary by removing the fastening element and pulling out the retaining bolt from the receiving bores provided in the fork cheeks.

Advantageous developments of the articulated coupling arrangement according to the disclosure emerge from the one or more embodiments disclosed herein.

The bearing running surface can be formed on a bearing shell inserted within a recess in the fastening eye. In this case, the bearing shell can be composed of a material which is selected specifically for the corresponding purpose and is in particular surface-hardened. The bearing shell is inserted into the recess with as little play as possible or in a force-fitting manner and fastened therein by means of a removable locking ring.

It is furthermore possible that the bearing ball is braced in a rotationally conjoint manner with the fork cheek via an intermediate spacer sleeve. The spacer sleeve can be formed in the form of a cylindrical elongation of a structural component of the bearing ball or, however, as a separate component. In the mounted state, the front end of the spacer sleeve facing away from the bearing ball is received by a stepped bore surrounding the receiving bore on the inside of the fork cheek with interference fit.

Means to prevent rotation which engage on the bearing ball and/or an inside of the fork cheek can be formed at the end side on the spacer sleeve. The end-side means can involve, for example, a crown margin formed on the spacer sleeve, which crown margin is pressed into the adjoining surface of the bearing ball or fork cheek during bracing of the bearing ball and thus leads to a corresponding increase in the friction coefficient.

The bearing ball typically runs in accordance with the predefined coupling position centered between the fork cheeks so that pendulum movements of the lifting spindle around the bearing ball occurring transversely to the pivot axis within the limits specified by the distance on both sides to the fork cheeks are permitted. This can be important in the event that deflections directed sideways on the lower links of the three-point power lift occur.

It is also possible that the fastening element is formed by a threaded bolt which engages through the receiving bore in the fork cheek, which is screwed into an internal thread provided at the end side on the retaining bolt and the head of which is supported on an outside of the fork cheek for bracing the bearing ball. A washer can be provided therebetween, for example, in the form of a Schnorr safety washer which secures the screw fastening. The open end of the retaining bolt which is opposite the screw fastening is supported in this case radially within the associated receiving bore in the opposite fork cheek of the lifting spindle.

In order to be able to build up a tightening torque which is sufficient for reliable protection against rotation, it can furthermore be provided that the retaining bolt has, on a side facing away from the internal thread, a receptacle for engagement of a tool for resistance during bracing of the bearing ball by means of the threaded bolt. The receptacle can involve an end-side screw head drive in the form of a hex or the like.

The above and other features will become apparent from the following detailed description and accompanying drawings.

### BRIEF DESCRIPTION OF THE DRAWINGS

The articulated coupling arrangement according to the disclosure will be explained in greater detail below using the appended drawings. Corresponding components or those with comparable function carry the same reference signs. In the drawings:

FIG. 1 shows an example embodiment represented in section of the articulated coupling arrangement according to the disclosure for a three-point power lift of an agricultural tractor;

FIG. 2 shows an exploded representation of the articulated coupling arrangement depicted in FIG. 1; and

FIG. 3 shows a schematically depicted three-point power lift of a conventional design on an agricultural tractor.

### DETAILED DESCRIPTION

The embodiments or implementations disclosed in the above drawings and the following detailed description are not intended to be exhaustive or to limit the present disclosure to these embodiments or implementations.

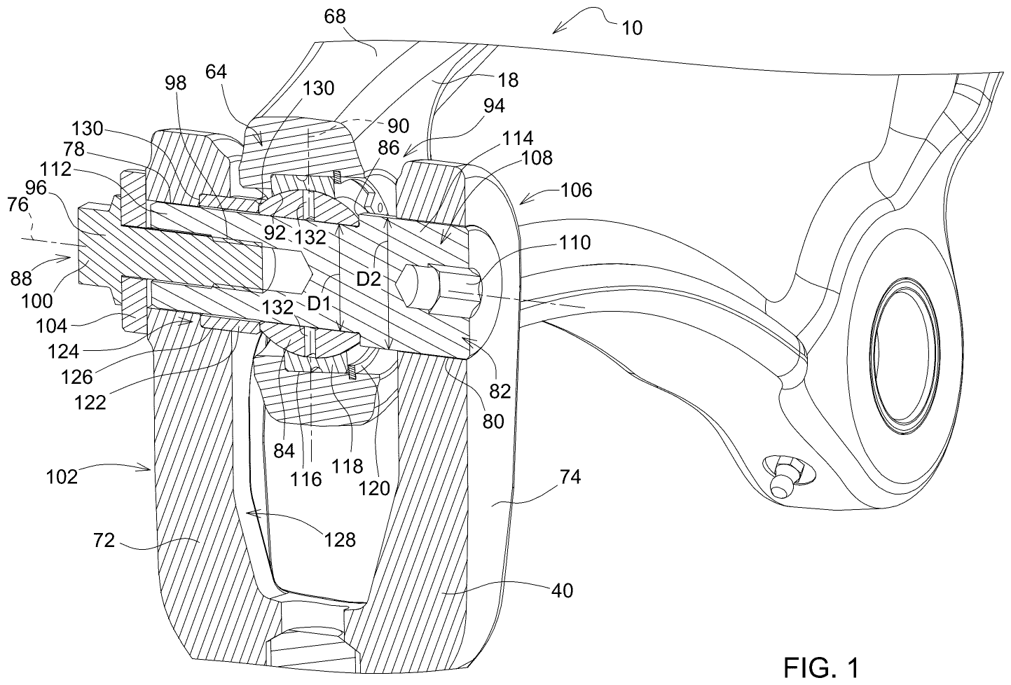

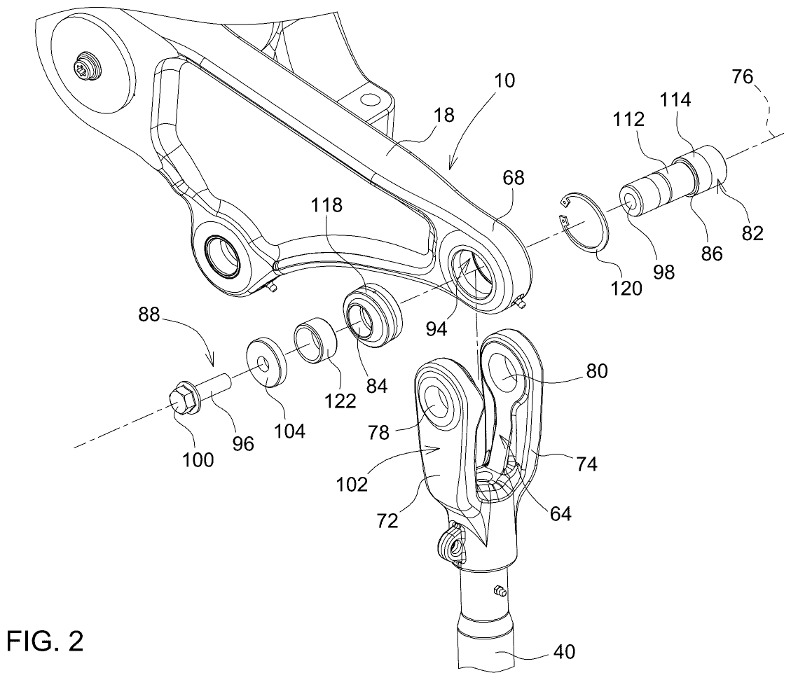

FIG. 1 shows an example embodiment represented in section of the articulated coupling arrangement according to the disclosure for a three-point power lift of an agricultural tractor, wherein this should be described below with simultaneous reference to the exploded representation in FIG. 2.

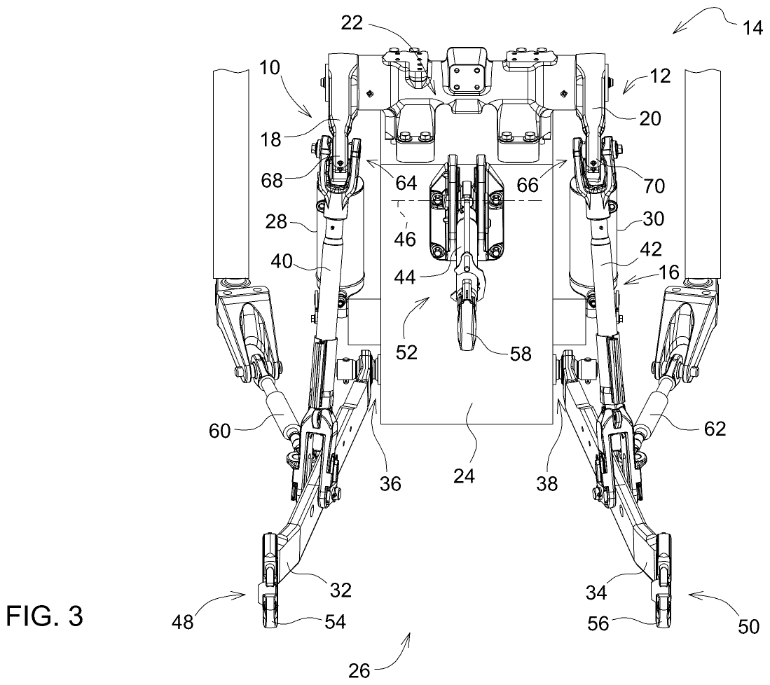

Typically, left-hand and right-hand articulated coupling arrangements 10, 12 are provided which have a mirror-symmetrical structure, but are otherwise identical. The articulated coupling arrangements 10, 12 are a component of a three-point power lift 14 of a conventional design reproduced by way of example in FIG. 3.

The three-point power lift 14 comprises a hydraulically actuable lifting mechanism 16 with left and right lifting arms 18, 20 which are articulated in an upper region 22 of a differential housing 24 of an agricultural tractor 26 and can be raised and lowered by means of associated left and right hydraulic cylinders 28, 30, as well as left and right lower links 32, 34 which are mounted at lower fastening points 36, 38 of the three-point power lift 14 in a vertically pivotable manner and are movement-connected to the lifting arms 18, 20 via length-adjustable lifting spindles 40, 42. Furthermore, a central upper link 44 which is suspended at an upper securing location 46 of the three-point power lift 14 so as to be able to be vertically pivoted is provided. Associated coupling arrangements 48, 50, 52 serve the purpose of reversible attachment of an attachment interface, not shown in FIG. 3. Generally, the coupling arrangements 48, 50, 52 involve detachable coupling hooks 54, 56, 58 provided on the lower links 32, 34 and the upper link 44 for receiving complementary coupling elements of an accessory or supplementary device to be attached thereto. Left and right side stabilizers 60, 62 make it possible to block sideways directed deflections of the lower links 32, 34 (lower link operation in central position), or, however, permit them to a certain extent (lower link operation in floating position). Each of the lifting spindles 40, 42 is connected in the region of an associated bearing point 64, 66 to a free end 68, 70 of the lifting arm 18, 20 articulated in a manner fixed on the tractor for pivoting actuation of a respective one of the two lower links 32, 34.

The left articulated coupling arrangement 10 will be described. The following explanations apply correspondingly to the right articulated coupling arrangement 12. As is apparent in FIGS. 2 and/or 3, opposite first and second fork cheeks 72, 74 or fork cheeks 72, 74 which run parallel to one another with receiving bores 78, 80 which are flush along an (imaginary) pivot axis 76 are formed on the associated lifting spindle 40. A cylindrical retaining bolt 82 is guided through the receiving bores 78, 80. A bearing ball 84 guided on the retaining bolt 82 is supported on a stop 86 formed on the retaining bolt 82 in such a manner that the bearing ball 84 can be braced by means of a fastening element 88 which engages on the retaining bolt 82 with respect to the first fork cheek 72 in a rotationally conjoint manner in a predefined coupling position 90 between the two fork cheeks 72, 74. In order to complete the bearing point 64, the bearing ball 84 is received by a bearing running surface 92 formed in a complementary manner within a fastening eye 94 of the lifting arm 18.

The fastening element 88 is formed by a threaded bolt 96 which engages through the receiving bore 78 in the first fork cheek 72, which is screwed into an internal thread 98 provided at the end side on the retaining bolt 82 and the head 100 of which is supported on an outside 102 of the first fork cheek 72 for bracing the bearing ball 84. A washer 104 is provided therebetween, for example, in the form of a Schnorr washer which secures the screw fastening. The open end 106 of the retaining bolt 82 opposite the screw fastening is supported in this case radially inside the associated receiving bore 80 in the second fork cheek 74 of the lifting spindle 40.

In order to be able to build up a tightening torque which is sufficient for reliable protection against rotation, it is furthermore provided that the retaining bolt 82 has, on a side facing away from the internal thread 98, a receptacle 108 for engagement of a tool for resistance during bracing of the bearing ball 84 by means of the threaded bolt 96. The receptacle 108 involves an end-side screw head drive in the form of a hex 110.

The retaining bolt 82 furthermore has a first portion 112 with a first external diameter D1 and a second portion 114 with a second external diameter D2 which is larger than this. The first portion 112 serves to receive the bearing ball 84 which bears against the stop 86, wherein the stop 86 is formed in the present case by a transition which is circumferential in a stepped manner to the second portion 114.

The bearing ball 85 involves a separate component which is pushed onto the cylindrical retaining bolt 82 with as little play as possible or in a form-fitting manner and can be removed or replaced where necessary by removing the threaded bolt 96 and pulling out the retaining bolt 82 from the receiving bores 78, 80 provided in both fork cheeks 72, 74.

According to FIG. 1, the bearing running surface 92 is formed on a bearing shell 118 inserted within a recess 116 in the fastening eye 94. In this case, the bearing shell 118 is composed of a material which is selected specifically for the corresponding purpose and is in particular surface-hardened. The bearing shell 118 is inserted into the recess 116 with as little play as possible or in a force-fitting manner and fastened therein by means of a removable locking ring 120.

The bearing ball 84 is braced in a rotationally conjoint manner with the first fork cheek 72 via an intermediate spacer sleeve 122. The spacer sleeve 122 can be formed in the form of a cylindrical elongation of a structural component of the bearing ball 84 or, however, as here as a separate component (see in this regard FIG. 2). In the mounted state, the front end 124 of the spacer sleeve 122 facing away from the bearing ball 84 is received by a stepped bore 126 surrounding the receiving bore 78 on the inside 128 of the first fork cheek 72 with interference fit.

Means to prevent rotation 130 which engage on the bearing ball 84 and/or the inside 128 of the first fork cheek 72 can be formed at the end side on the spacer sleeve 122. The end-side means to prevent rotation 130 involves a crown margin (not shown) formed on the spacer sleeve 122, which crown margin is pressed into the adjoining surface of the bearing ball 84 or first fork cheek 72 during bracing of the bearing ball 84 and thus leads to a corresponding increase in the friction coefficient.

The bearing ball 84 typically runs in accordance with the predefined coupling position 90 centered between the two fork cheeks 72, 74 so that pendulum movements of the lifting spindle 40 around the bearing ball 84 occurring transversely to the pivot axis 76 within the limits specified by the distance on both sides to the two fork cheeks 72, 74 are permitted. This can be important in the event that deflections directed sideways on the lower links 32, 34 of the three-point power lift 34 occur, therefore when these are operated in the floating position.

As can likewise be seen in FIG. 1, several diametrical lubricant channels 132 which make it possible to supply the bearing running surface 92 with lubricating grease via a lubricating nipple (not shown) provided on the lifting arm 18 run through a wall of the bearing ball 84.

Since both the bearing ball 84 and the retaining bolt 82 running therein are braced in a rotationally conjoint manner and thus fixed with respect to the first fork cheek 72, the latter is no longer exposed to the movements which occur at the bearing point 64 and thus operationally induced wear caused in this regard. The retaining bolt 82 merely serves here to support the lifting loads which occur at the bearing point 64 or the rotationally conjoint bracing of the bearing ball 84 with respect to the first fork cheek 72 by means of the threaded bolt 96. The larger bearing running surface 92 in comparison with the otherwise normal use of a cylindrical bearing bolt also leads to correspondingly reduced wear of the bearing point 64.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the drawings, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. An articulated coupling arrangement for a three-point power lift of an agricultural tractor, comprising:
a lifting arm articulated to be raised and lowered by a lifting mechanism;
a lifting spindle connected to a free end of the lifting arm in a bearing position for pivoting actuation of a lower link having a coupling arrangement for reversible attachment of an attachment interface;
first and second opposing fork cheeks with receiving bores flush along a joint axis being formed on the lifting spindle, through which receiving bores a retaining bolt is guided; and
a bearing ball guided on the retaining bolt being supported on a stop formed on the retaining bolt such that that the bearing ball can be braced by a fastening element engaging the retaining bolt with respect to the first fork cheek in a rotationally conjoint manner in a predefined coupling position between the first and second fork cheeks, the bearing ball being accommodated within a fastening eye of the lifting arm for the formation of the bearing point of a bearing running surface formed in a complementary manner.

2. The articulated coupling arrangement of claim 1, wherein the bearing running surface is formed on a bearing shell inserted within a recess in the fastening eye.

3. The articulated coupling arrangement of claim 1, wherein the bearing ball is braced in a rotationally conjoint manner with the first fork cheek via an intermediate spacer sleeve.

4. The articulated coupling arrangement of claim 1, wherein a crown margin formed at the end side on the spacer sleeve engages at least one of the bearing ball and an inside of the first fork cheek.

5. The articulated coupling arrangement of claim 1, wherein the bearing ball runs in accordance with the predefined coupling position centered between the first and second fork cheeks.

6. The articulated coupling arrangement of claim 1, wherein the fastening element is formed by a threaded bolt which engages through the receiving bore in the first fork cheek, which is screwed into an internal thread provided at the end side on the retaining bolt and the head of which is supported on an outside of the first fork cheek for bracing the bearing ball.

7. The articulated coupling arrangement of claim 6, wherein the retaining bolt has, on a side facing away from the internal thread, a receptacle for engagement of a tool for resistance during bracing of the bearing ball by the threaded bolt.

8. An agricultural tractor including an articulated coupling arrangement for a three-point power lift, comprising:
a lifting arm articulated to be raised and lowered by a lifting mechanism;
a lifting spindle connected to a free end of the lifting arm in a bearing position for pivoting actuation of a lower link having a coupling arrangement for reversible attachment of an attachment interface;
first and second opposing fork cheeks with receiving bores flush along a joint axis being formed on the lifting spindle, through which receiving bores a retaining bolt is guided; and
a bearing ball guided on the retaining bolt being supported on a stop formed on the retaining bolt such that that the bearing ball can be braced by a fastening element engaging the retaining bolt with respect to the first fork cheek in a rotationally conjoint manner in a predefined coupling position between the first and second fork cheeks, the bearing ball being accommodated within a fastening eye of the lifting arm for the formation of the bearing point of a bearing running surface formed in a complementary manner.

9. The agricultural tractor of claim 8, wherein the bearing running surface is formed on a bearing shell inserted within a recess in the fastening eye.

10. The agricultural tractor of claim 8, wherein the bearing ball is braced in a rotationally conjoint manner with the first fork cheek via an intermediate spacer sleeve.

11. The agricultural tractor of claim 8, wherein a crown margin formed at the end side on the spacer sleeve engages at least one of the bearing ball and an inside of the first fork cheek.

12. The agricultural tractor of claim 8, wherein the bearing ball runs in accordance with the predefined coupling position centered between the first and second fork cheeks.

13. The agricultural tractor of claim 8, wherein the fastening element is formed by a threaded bolt which engages through the receiving bore in the first fork cheek, which is screwed into an internal thread provided at the end side on the retaining bolt and the head of which is supported on an outside of the first fork cheek for bracing the bearing ball.

14. The agricultural tractor of claim 13, wherein the retaining bolt has, on a side facing away from the internal thread, a receptacle for engagement of a tool for resistance during bracing of the bearing ball by the threaded bolt.
